(19) United States
(12) Patent Application Publication
(10) Pub. No.: US 2019/0137024 A1
(43) Pub. Date: May 9, 2019

(54) Fusible Size-On-Size Or Reduced Branch Fitting For Use With Polyethylene Pipe

(71) Applicant: TDW Delaware, Inc., Wilmington, DE (US)

(72) Inventors: Grant Cooper, Broken Arrow, OK (US); Jared Sickles, Tulsa, OK (US)

(21) Appl. No.: 16/181,975

(22) Filed: Nov. 6, 2018

Related U.S. Application Data
(60) Provisional application No. 62/582,046, filed on Nov. 6, 2017.

(51) Int. Cl. F16L 41/06; F16L 13/02

(52) U.S. Cl. CPC F16L 41/06; F16L 13/02

(57) ABSTRACT

A fusible fitting of this disclosure includes a saddle having a radially extending branch with a closed bottom end. The closed bottom end forms a portion of the saddle and contains some of the fusion wires that run through the saddle. After the fitting is fused to a pipe, the closed bottom end may be tapped through, with that portion of the fusion wires being removed along with the coupon. Because of this configuration, the branch may be a size-on-size or near size-on-size branch. For example, the radially extending branch may have an inside diameter in a range of greater than 75% of an inside diameter of the pipe to 100% of the inside diameter of the pipe plus one wall thickness of the pipe.

### CROSS-REFERENCE TO RELATED APPLICATION

The present application is a conversion of U.S. Provisional Patent Application No. 62/582,046 filed Nov. 6, 2017. The subject matter of which is incorporated herein by reference.

### BACKGROUND

This disclosure is in the field of fusible fittings for use with thermoplastic polymer pipe such as but not limited to polyethylene pipe like that used in gas distribution systems. In particular, the disclosure addresses fusible fittings capable of use in hot tap operations.

Prior art fusible fittings do not provide a size-on-size or a near size-on-size branch because the open bottom end of the branch reduces the amount of space available for fusion wires and affects where the resistance elements or fusion wires can be placed.

### SUMMARY

Embodiments of a fusible fitting of this disclosure comprise a first saddle made of a thermoplastic polymer material, the first saddle containing a first set of fusion elements and a radially extending branch including a closed bottom end, at least some of the fusion elements of the first set being contained in the closed bottom end of the radially extending branch. The fusion elements may be arranged in a serpentine path throughout the fitting. The thermoplastic polymer material may include a crystalline thermoplastic polymer material, a semi-crystalline thermoplastic polymer material, an amorphous thermoplastic polymer material, or some combination thereof. A second saddle made of a thermoplastic polymer material may be arranged opposite the first saddle and include a second set of fusion elements. This second saddle may also include a radially extending branch with the closed bottom end. The first and second saddles may also include wings that contain fusion elements.

In some embodiments the radially extending branch has an inside diameter (“ID”) in a range of greater than 75% of the ID of the pipe to 100% of the ID of the pipe plus one wall thickness of the pipe. In other embodiments, the radially extending branch has an ID equal to that of the pipe. In yet other embodiments, the radially extending branch has an ID no greater than 75% of the pipe's ID. The radially extending branch may be arranged perpendicular to the pipe, that is, its central (radially extending) axis is perpendicular to that of the pipe's central (axially extending) axis, or it may be arranged at an oblique angle.

In embodiments of a method for making a saddle branch connection to a plastic or non-metallic pipe, the method comprises inserting a tapping tool into a radially extending branch of a fusible fitting fused about the non-metallic pipe, the radially extending branch including a closed bottom end having fusion elements passing through it; and tapping through the closed bottom end, the fusion elements passing through the closed bottom end, and a sidewall of the non-metallic pipe adjacent to the closed bottom end. The fusible fitting may be the same or similar to the one described above, the radially extending branch being a size-on-size branch, a near size-on-size, or a reduced branch. The method may further comprise removing a coupon, the coupon including at least a portion of the cut closed bottom end, the cut fusion elements, and the cut sidewall. The tapping may be a hot tap.

### BRIEF DESCRIPTION OF THE DRAWINGS

FIG. 1 is an isometric view of an embodiment of a fusible fitting of this disclosure.

FIG. 2 is a cross-section view of the fitting of FIG. 1.

FIG. 3 is an isometric view of another embodiment of a fusible fitting of this disclosure.

FIG. 4 is a cross-section view of the fitting of FIG. 3.

FIG. 5 is an embodiment of the fitting arranged about a pipe for fusion to the pipe.

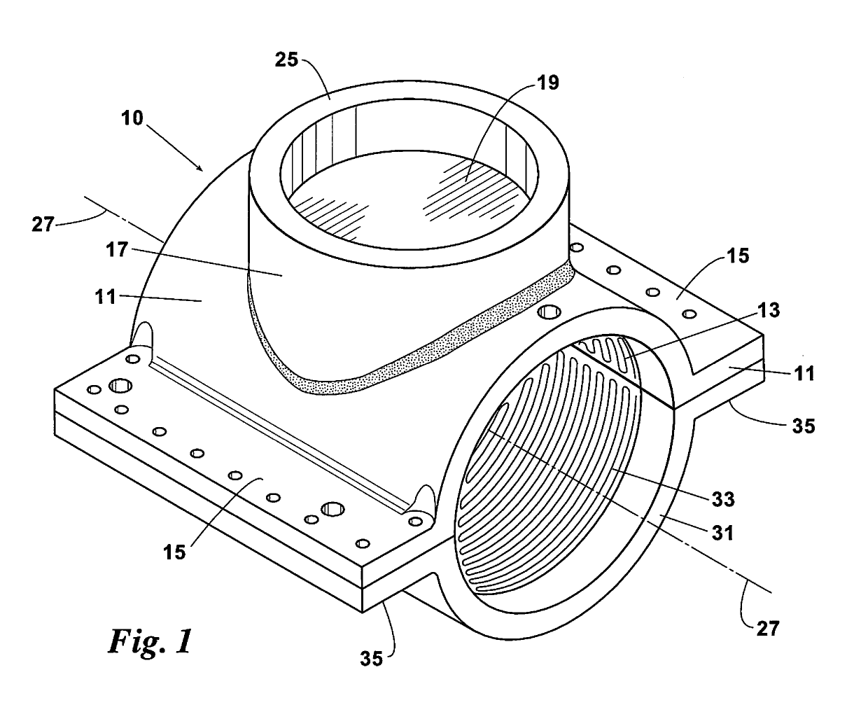

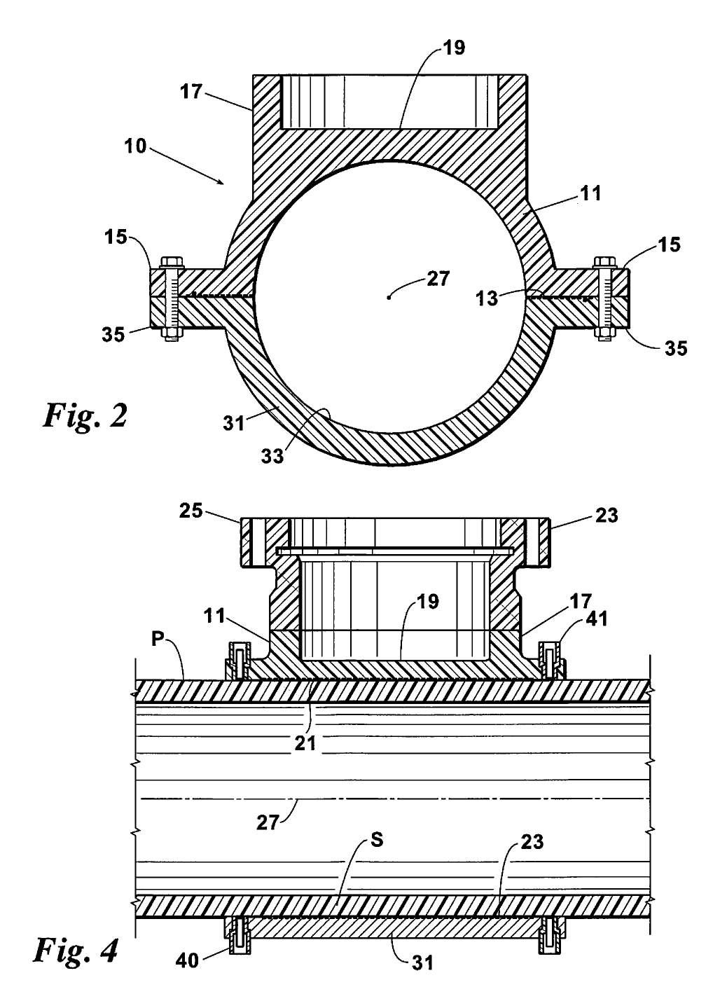

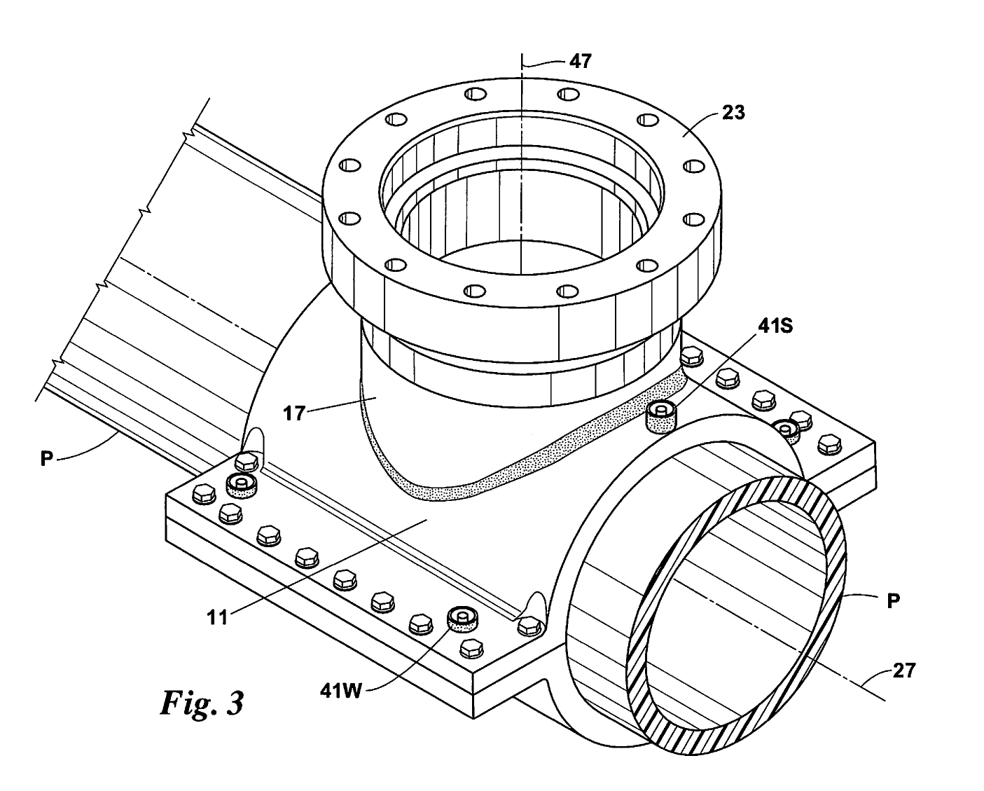

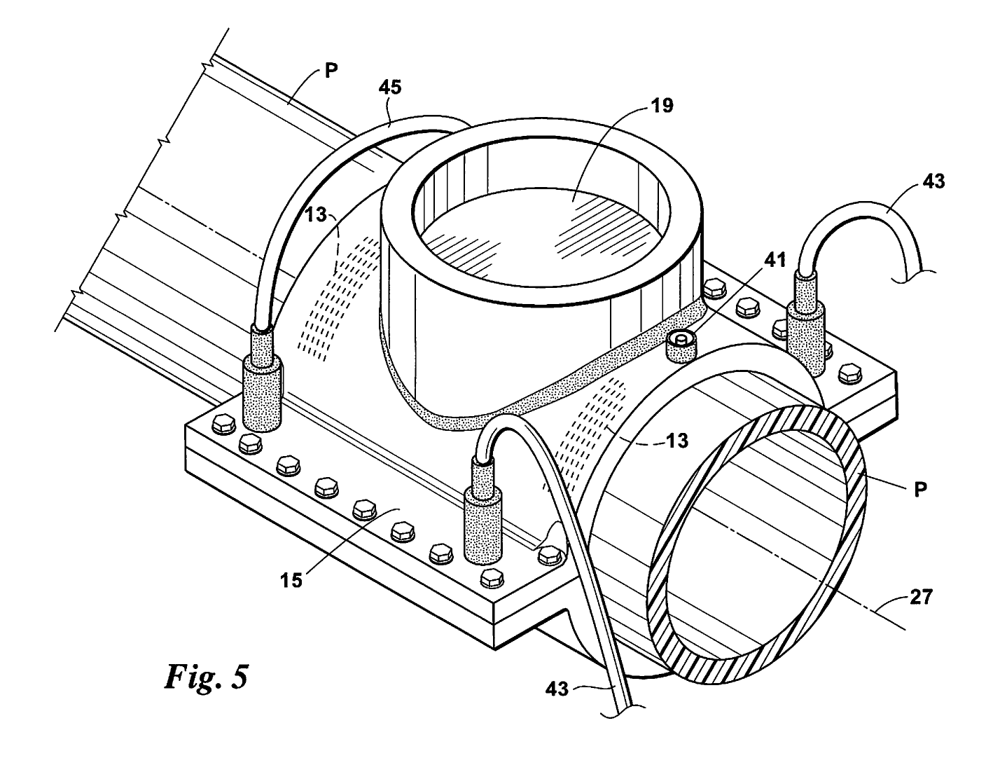

### ELEMENTS AND NUMBERING USED IN THE DRAWINGS AND DETAILED DESCRIPTION

10 Fitting;

11 First (upper) saddle;

13 First set of fusion wires;

15 Wing;

17 Radially extending branch;

19 Closed bottom end;

21 Portion of fusion wires contained by 19;

23 Flange;

25 Top end;

27 Central (axial direction) axis of pipe P;

31 Second (lower) saddle;

33 Second set of fusion wires;

35 Wing;

40 Fusion means;

41 Terminal (41S terminal on saddle. 41W terminal on wing);

43 Lead;

45 Jumper;

47 Central (radial direction) axis of branch 17;

P Pipe;

W Sidewall lying opposite, and in contact with, 11 or 31.

### DETAILED DESCRIPTION

The embodiments described here provide illustrative examples of a fusible fitting configured for use on thermoplastic polymer pipe such as but not limited to polyethylene pipe like that used in gas distribution systems. A person of ordinary skill in the art would recognize that modifications may be made to these embodiments without departing from the scope and spirit of this disclosure or the claims that follow their description. Those claims include the full range of equivalents to which the recited elements are entitled.

In some embodiments, the pipe may be polyethylene pipe, for example, PE80 or PE100 polyethylene pipe. By way of a non-limiting example, in some embodiments the fitting and pipe are configured for use in an oil or gas application. In other embodiments, the fitting and pipe are configured for use in a water application. The nominal pipe size of the pipe may be in a range of 100 DN to 600 DN (4-inch [114.3 mm] to 24-inch [610 mm]), including other ranges and sub-ranges within this broader range. Pipe wall thickness within each DN size, and therefore ID, may vary depending on pressure rating. Standards known in the art are used for specifying the nominal pipe size and wall thickness. Embodiments of the fitting may be fully machined or injection molded.

A novel feature of a fusible fitting of this disclosure is a saddle that includes a radially extending branch having a closed bottom end. The closed bottom end contains a portion of the fusion wires that run through the saddle. In other words, the fusion wires run through the closed bottom end in a similar fashion as the wires run through other portions of the saddle. After the fitting is fused to the pipe, the closed bottom end may be tapped through, with that portion of the fusion wires removed along with the coupon. Because of this configuration, the branch may be a size-on-size or near size-on-size branch (and may also be a reduced branch). Prior art fusible fittings do not provide a size-on-size or a near size-on-size branch because the branch has an open bottom end that cannot contain any fusion wires. The open bottom end reduces the amount of space available for fusion wires and affects where the resistance elements or fusion wires can be placed.

For purposes of this disclosure, a reduced branch means a branch inside diameter (“ID”) equal to no more than 75% of the ID of pipe P. A size-on-size or near size-on-size branch means a branch ID in a range greater than 75% of the ID of pipe P to the ID of pipe P plus one wall thickness of the pipe P. Where the term, run, is used, it means at least one pipe to which the fitting is being fused.

Referring now to the drawings, in embodiments the fitting 10 of this disclosure may include a first (upper) 11 and a second (lower) saddle 31 made of a thermoplastic polymer material, each saddle 11, 31 containing a set of resistance elements or fusion wires 13, 33 running through the respective saddle 11, 31. When used in combination with one another, the two saddles 11, 31 provide full encirclement of a pipe P. The thermoplastic polymer material used in the saddles 11, 31 may include a crystalline polymer, a semi-crystalline polymer, an amorphous polymer, or some combination thereof. The fusion wires 13, 33 may be of a kind known in the art and may run back-and-forth in a non-linear or serpentine manner through the respective saddle 11, 31.

The fitting 10 may also include means 40 known in the art for connecting the fusion wires 13, 33 to a source of electric current (not show) for fusion. These means may include terminals 41 in circuit relationship with the fusion wires 13, 33 and connected by leads 43 to a fusion welding machine of a kind known in the art. The terminals 41S are typically located on the saddles 11, 31. Terminals 41W are typically located along the wings 15, 35 of the saddle 11, 31. In embodiments, the fitting 10 may include four fusion areas: a top half circle, a bottom half circle, and two wings. The fitting 10 may include a jumper 45 so that fusion occurs in two stages, for example, in the top and bottom half circles together and in the wings together.

The first saddle 11 includes a radially extending branch 17 having a closed bottom end 19 that forms a portion of the first saddle and contains a portion 21 of the first set of fusion wires 13. The radially extending branch 17 may be a size-on-size branch or a near size-on-size branch. In some embodiments, the branch may be a reduced size branch. The branch 17 may also include a flange 23 at its top end 25. The top end 25 may be an open end. In some embodiments, the central (radially extending) axis 47 of the branch 17 is arranged perpendicular to a central (axially extending) axis 27 of pipe P. In other embodiments, the central axis 47 of the branch 17 is arranged at an oblique angle to the axis 27.

To gain access to an interior space of a pipe P, the fitting 10 is fused onto the pipe P and a tapping tool (not shown) of a kind known in the art cuts through the closed bottom end 19 of the branch and into a sidewall W of the pipe P. During this tapping operation, the fusion wires 21 passing through the closed bottom end 19 are cut and become part of the coupon to be removed by the tool. The coupon includes the closed bottom end 19, the cut portions of the fusion wires 21, and the cut portion of the pipe sidewall W.

Embodiments of a method that uses the fitting 10 to provide an opening through a sidewall W of the pipe P includes fusing the fitting 10 at a desired location on the pipe P, inserting a tapping tool into the radially extending branch 17 of the fitting 10, and tapping through the closed bottom end 19 of the branch 17 and the sidewall W into an interior of the pipe P. This tapping-through cuts through the fusion wires 21 that pass through the closed bottom end 19, which now forms part of the coupon along with the removed portion of the sidewall W. The tapping operation may be a hot tap. In applications where a bottom outlet is desired, the second saddle 31 may also include the radially extending branch 17 including the closed bottom end 19 with fusion wires 33. Where both saddles 11, 31 include the branch 17, tapping operations cut through the fitting 10 and the pipe P.

1. A fusible fitting comprising:
a first saddle made of a thermoplastic polymer material and including a first set of fusion elements and a radially extending branch connected to the first saddle;
the radially extending branch including a closed bottom end that forms a portion of the first saddle, at least a portion of the fusion elements of the first set of fusion elements being contained in the closed bottom end.

2. A fusible fitting according to claim 1 further comprising a second saddle made of a thermoplastic polymer material and including a second set of fusion elements.

3. A fusible fitting according to claim 2, the second saddle including a radially extending branch connected to the second saddle; the radially extending branch of the second saddle including a closed bottom end that forms a portion of the second saddle, at least a portion of the fusion elements of the second set of fusion elements being contained in the closed bottom end of the radially extending branch of the second saddle.

4. A fusible fitting according to claim 1, the fusible fitting configured for use with a pipe having a nominal pipe size, the radially extending branch having an inside diameter in a range of greater than 75% of an inside diameter of the pipe to 100% of the inside diameter of the pipe plus one wall thickness of the pipe.

5. A fusible fitting according to claim 1, the fusible fitting configured for use with a pipe having a nominal pipe size, the radially extending branch having an inside diameter equal to an inside diameter of the pipe.

6. A fusible fitting according to claim 1, the fusible fitting configured for use with a pipe having a nominal pipe size, the radially extending branch having an inside diameter no greater than 75% of an inside diameter of the pipe.

7. A fusible fitting according to claim 1, a central radially extending axis of the radially extending branch being arranged perpendicular to a central axially extending axis.

8. A fusible fitting according to claim 1, a central radially extending axis of the radially extending branch being arranged oblique to a central axially extending axis.

9. A fusible fitting according to claim 1, wherein fusion elements are arranged in a serpentine path.

10. A fusible fitting according to claim 1, the thermoplastic polymer material including a crystalline thermoplastic polymer material.

11. A fusible fitting according to claim 1, the thermoplastic polymer material including a semi-crystalline thermoplastic polymer material.

12. A fusible fitting according to claim 1, the thermoplastic polymer including an amorphous thermoplastic polymer material.

13. A method of making a saddle branch connection to a non-metallic pipe including
a thermoplastic polymer material, the method comprising:
inserting a tapping tool into a radially extending branch of a fusible fitting made of a thermoplastic polymer material and fused about the non-metallic pipe, the radially extending branch including a closed bottom end having fusion elements passing through it;
tapping through the closed bottom end of the radially extending branch, the fusion elements passing through the closed bottom end, and a sidewall of the non-metallic pipe lying opposite, and in contact with, the closed bottom end.

14. A method according to claim 13, further comprising:
prior to the inserting the tapping tool,
placing the fusible fitting at a predetermined location on the non-metallic pipe; and
fusing the fusible fitting onto the non-metallic pipe by passing an electric current through fusion elements of the fusible fitting, the closed bottom end being fused to the non-metallic pipe.

15. A method according to claim 13, wherein the radially extending branch has an inside diameter in a range of greater than 75% of an inside diameter of the non-metallic pipe to 100% of the inside diameter of the non-metallic pipe plus one wall thickness of the non-metallic pipe.
